(19) United States
(12) Patent Application Publication
(10) Pub. No.: US 2014/0067515 A1
(43) Pub. Date: Mar. 6, 2014

(54) SYSTEMS AND METHODS FOR PRICING ELECTRONIC CONTENT ITEMS

(71) Applicant: Clayton Tummons, Springfield, MO (US)

(72) Inventor: Clayton Tummons, Springfield, MO (US)

(73) Assignee: ARTISTSIGNAL, INC., Springfield, MO (US)

(21) Appl. No.: 13/605,871

(22) Filed: Sep. 6, 2012

(51) Int. Cl. G06Q 30/02

(52) U.S. Cl. 705/14.39

(57) ABSTRACT

Techniques for facilitating transactions for electronic content items are described. Some embodiments provide a media marketplace system that provides a marketplace for electronic content items, such as songs, videos, electronic books, and the like. In some embodiments, the media marketplace system facilitates group purchase discount transactions. A group discount transaction provides for the sale of an electronic content item at a discounted price if a sufficient number of buyers indicate a willingness to purchase the electronic content item at the discounted price within a limited time period.

### FIELD OF THE INVENTION

The present disclosure relates to methods, techniques, devices, and systems for facilitating transactions for content items and, more particularly, to methods, techniques, devices, and systems for managing group purchase discount transactions for electronic content items, such as digitally recorded songs, videos, images, and the like.

### BACKGROUND OF THE INVENTION

A number of approaches to selling and distributing electronic content items exist. In one approach, songs, videos, or other types of electronic content items are made available via a Website or other network accessible system. Typically, these content items are offered for sale at a fixed price. A potential buyer can either accept the offer at the stated price or refuse the offer and be denied the enjoyment of the song.

The above-described “take or leave it” model of pricing suffers from a number of drawbacks. First, no sales will be made to those buyers who desire the content item, but who are not willing to pay the asking price. For example, if the content item is offered for sale at $1.00, there may be hundreds or thousands of potential buyers who would be willing to pay some lower price, such as $0.75. Since no sale will be made to these lower-price potential buyers, the seller of the content item will not obtain the revenues and/or profits that would derive from such sales. Second, potential buyers who are not willing to pay the offer price may instead turn to other techniques, including online piracy, for obtaining the content item, thereby further denying the seller of income.

Some approaches offers discounts for bulk purchases of content items. For example, an album or group of songs may be offered at a discount relative to the per-song price. Thus, an album that includes 10 songs (normally offered for $1.00 each) may be offered for $9.00. While this approach does result in a lower per-song price for some buyers, it still excludes all of those buyers who are only interested in less than the entire album and who would be willing to purchase those songs at a lower price.

### BRIEF DESCRIPTION OF THE DRAWINGS

Preferred and alternative examples of the present invention are described in detail below with reference to the following drawings:

FIG. 1 is a block diagram of an example embodiment of a media marketplace system.

FIGS. 2A-2C illustrate user interface screens for engaging in a group purchase discount transaction for an electronic content item.

FIGS. 3A-3C illustrate mobile device user interface screens for engaging in a group purchase discount transaction for an electronic content item.

FIGS. 4A-4G illustrate user interface screens for establishing a group purchase discount associated with an electronic content item.

FIG. 5 is a flow diagram of an example deal manager process according to an example embodiment.

FIG. 6 is a block diagram of an example computing system for implementing a media marketplace system according to an example embodiment.

### DETAILED DESCRIPTION

Embodiments described herein provide enhanced computer- and network-based methods and systems for facilitating media transactions and, more particularly, for managing group purchase discount transactions for electronic content items. Example embodiments provide or are implemented in the context of a media marketplace system (“MMS”) configured to facilitate transactions for electronic content items, such as songs, images, videos, electronic books, or the like. In some embodiments, the media marketplace system is configured to receive and store electronic content items from content providers, such as individual artists, media publishers, aggregators, distributors, studios, or the like. Buyers may then access the media marketplace system to search, browse, and/or purchase available content items according to the techniques described herein.

Some embodiments may facilitate group purchase discount transactions for content items. A content provider may establish a group purchase discount (sometimes also referred to as a “deal”) for an associated content item. A group purchase discount may include a base price and a discount price for the content item, along with a minimum number of buyers that must accept the deal in order to obtain the discount price for the content item. The group purchase discount may further include a time period during which the deal is available. If at least the minimum number of buyers accepts the deal within the time period, those buyers receive the content item at the discount price. On the other hand, if the time period runs or expires prior to reaching the minimum number of buyers, the buyers do not receive the content item unless they otherwise indicate a willingness to purchase the item at the base price.

### Overview of an Example Media Marketplace System

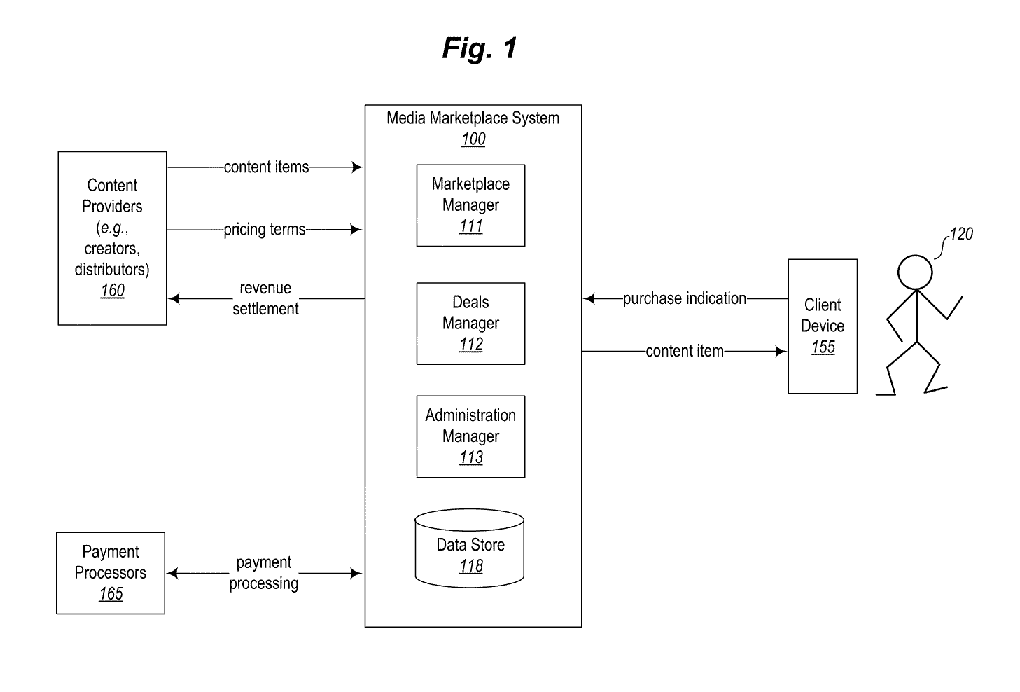

FIG. 1 is a block diagram of an example embodiment of a media marketplace system. FIG. 1 depicts a media marketplace system (“MMS”) 100 interacting with content providers 160, a buyer 120, and payment processors 165. The media marketplace system 100 includes a marketplace manager 111, a deals manager 112, an administration manager 113, and a data store 118.

The marketplace manager 111 generally manages an online marketplace provided by the media marketplace system 100. The marketplace manager 111 receives content items (or indications thereof) and corresponding price information from the content providers 160. The content providers 160 include any entity that provides content to the media marketplace system 100, including individual artists, media publishers, aggregators, distributors, studios, or the like. The content providers 160 provide content items by uploading or otherwise transmitting content items to the marketplace manager 111. In other embodiments, the content providers provide an indication (e.g., a URL) of a content item, which can be used by the marketplace manager 111 to retrieve or later access the content item. The marketplace manager 111 stores received content items in the data store 118.

The marketplace manager 111 facilitates sales of content items to the buyer 120 who operates a client device 155. For example, the marketplace manager 111 may provide indications and/or samples of available content items to the client device 155. The buyer 120 may then operate the client device 155 to select a content item, and to transmit an indication to purchase the selected content item along with payment information (e.g., credit card information). In response, the marketplace manager 111 interacts with one of the payment processors 165 to obtain a payment. The marketplace manager 111 then provides some or all of the payment to the appropriate content provider 160. Typically, the media marketplace system 100 retains some fraction (e.g., 5%) of the payment. Once payment has been received, the marketplace manager 111 provides access to the purchased content item to the buyer 120, such as by transmitting a URL or other network reference that can be used to download the content item to the client device 155.

The deals manager 112 generally manages group purchase discount transactions. When a content provider 160 provides a content item for sale, the content provider may specify pricing information that initiates the creation of a group purchase discount associated with the content item. For example, the content provider 160 may specify a deal that includes discount price along with a minimum number of buyers and a time period. The deals manager 112 may then record (in the data store 118) the terms of the deal.

After the creation of a deal, the deals manager 112 tracks the deal throughout its lifecycle. In particular, the deals manager 112 receives (e.g., from the marketplace manager 111) indications that buyers have accepted or otherwise expressed an interest in the deal. Once the minimum number of buyers is reached, the deals manager 112 causes the marketplace manager 111 to process payments and prove access to the content item to each of the buyers, as discussed above. On the other hand, if the time period corresponding to the deal runs prior to reaching the required number of buyers, the deals manager 112 notifies the buyers of that fact, and optionally provides them with the option to purchase the content item at the non-discounted price.

The administration manager 113 generally manages user accounts and other administrative functions related to the operation of the media marketplace system 100. For example, a new content provider may register for a seller account via the administration manager 112. As another example, a buyer may establish an account in order to conveniently store buyer information (e.g., credit card information) and preferences (e.g., music genres). User accounts and related information are stored in the data store 118 by the administration manager.

FIG. 1 represents just one possible architecture or arrangement for implementing the described techniques. In particular, the functions of the media marketplace system 100 may be decomposed or distributed in different manners in other embodiments. For example, the functions of the marketplace manager 111 and the deals manager 112 may be merged into a single module in some other embodiment. As another example, the deals manager 112 may provide its services to other, third-party marketplaces or distributors of content items.

Also, the described media marketplace system 100 may perform different functions in other embodiments. For example, the media marketplace system 100 may perform additional functions such as retaining copies of content items so that buyers can re-download or otherwise continue to access content items when they wish to migrate or recover their content collection/library. As another example, the media marketplace system 100 may include a facility for collecting donations and/or tips on behalf of artists or other types of content providers.

### Example User Interface Aspects

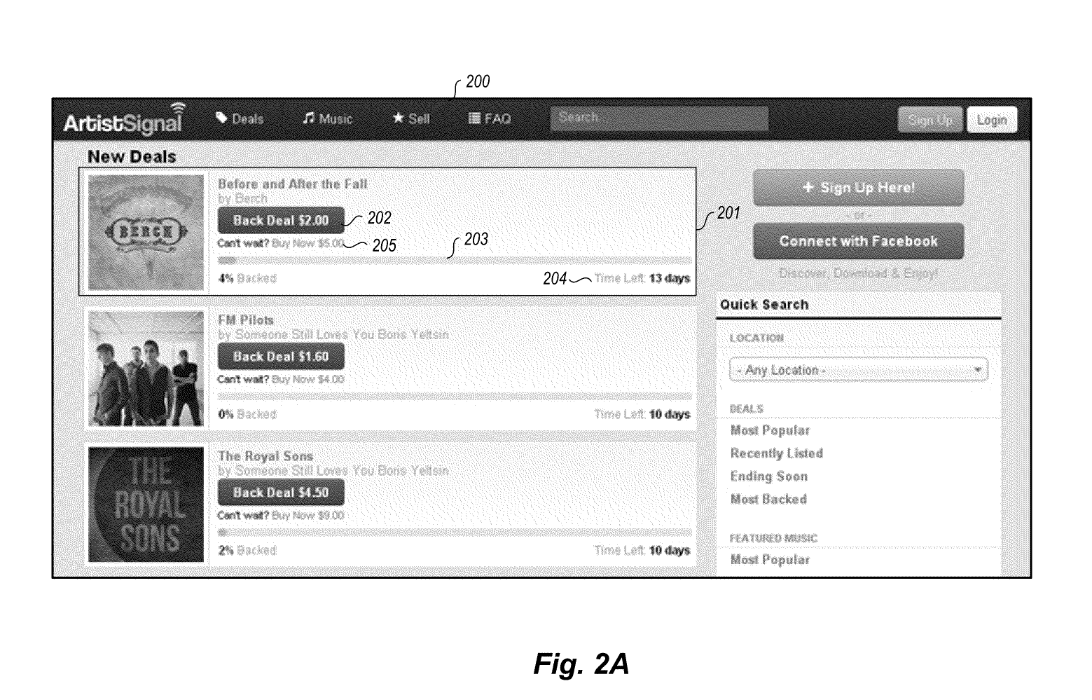

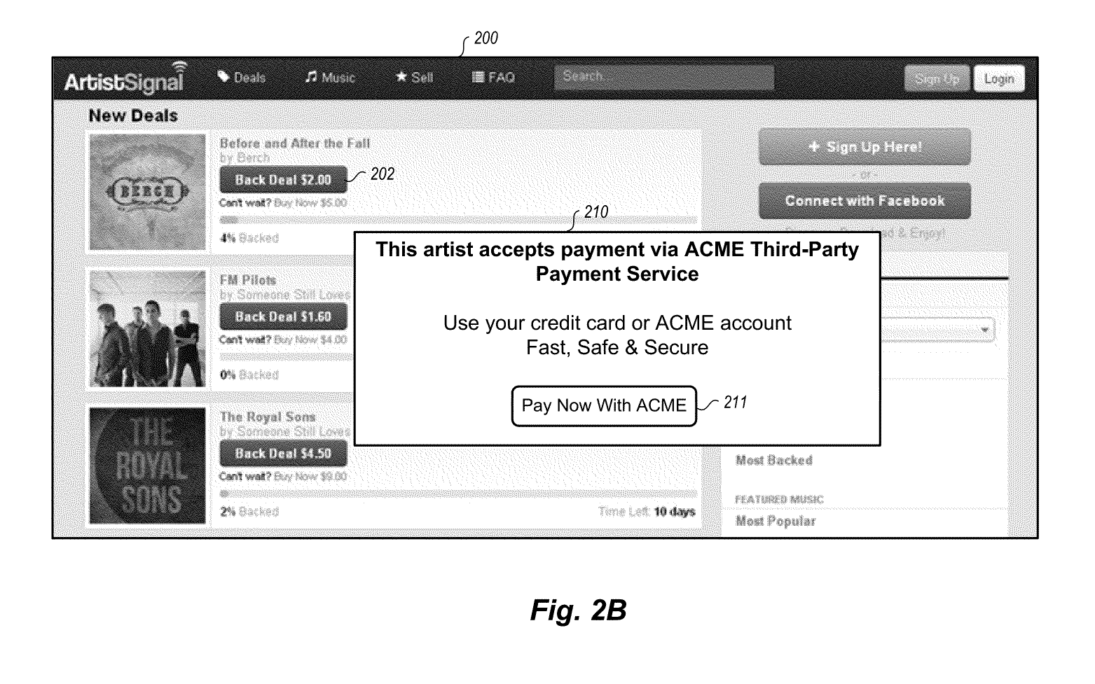

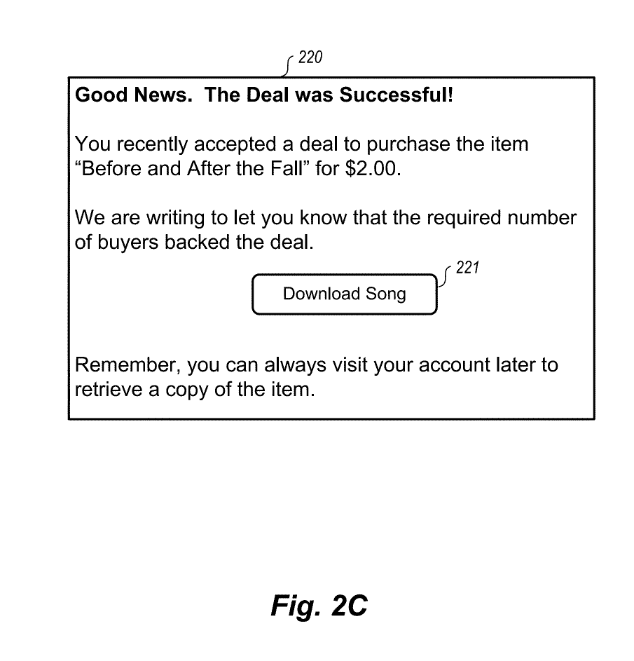

FIGS. 2A-2C illustrate user interface screens for engaging in a group purchase discount transaction for an electronic content item. FIG. 2A depicts a user interface screen 200 that displays information about content items available via an example media marketplace system. The screen 200 also includes various user interface controls for browsing and/or searching for content items, for establishing or logging into an account with the media marketplace system, and the like.

The screen 200 includes a deal area 201. The deal area 201 displays information about a corresponding deal and includes controls for accepting the deal. More particularly, the deal area 201 includes a name and image (e.g., album art) of the content item, along with an accept deal control 202, a deal progress bar 203, and a time remaining indicator 204.

The accept deal control 202 displays the discount price associated with the deal (e.g., $2.00). The accept deal control 202 is also configured, when selected by a buyer, to provide an indication to the media marketplace system that the buyer has accepted the deal. In response, the media marketplace system records the indication, such that it can determine whether at least the minimum number of buyers have accepted the deal.

The deal progress bar 203 graphically depicts how many buyers have accepted the deal. In this example, the deal progress bar 203 is a horizontal bar graph that includes a component that has a length that is proportional to the percentage (e.g., 4%) of the required minimum number of buyers that have accepted the deal. For example, if the deal requires 100 buyers to grant the discount price of $2.00, the progress bar 203 will show 4% engagement if 4 buyers have accepted the deal.

The deal progress bar 203 dynamically updates in response to additional buyers accepting the deal. For example, if a current buyer selects the accept deal control 202, the deal progress bar 203 updates to reflect the additional acceptance. In some embodiments, the deal progress bar 203 may dynamically update in response to other buyers (e.g., who are using a different instance of the illustrated user interface) accepting the deal. A user of the screen 200 may thus be provided with a real time depiction or animation of growing interest in a particular content item, which may advantageously encourage the user to also become a buyer of the content item.

The time remaining indicator 204 provides an indication of how much time remains with respect to the depicted deal. In this example, 13 days are remaining during which at least the minimum number of buyers must accept the deal. Continuing the above example, where the deal requires at least 100 buyers and 4 buyers have accepted the deal, at least another 96 buyers would need to accept the deal within the remaining 13 days in order to trigger the deal.

The time remaining indicator 204 may also be dynamically updated in response to the passage of time. For example, during the last hour of a deal, the time remaining indicator may animate a countdown of minutes and seconds in order to instill a sense of urgency in potential buyers.

Note also that the deal area 201 provides an option (e.g., “Can't wait? Buy Now $5.00”) and corresponding control 205 (a link in this example) to purchase the content item immediately. A buyer who does not want to wait until the deal is triggered (or the deal time otherwise expires) may select the control 205 in order to purchase the content item immediately. In some embodiments, every buyer who purchases the content item immediately is also counted towards the minimum number of buyers who must accept the deal. In this manner, the deal is not “punished” for buyers who are actually willing to pay more than the discount price to obtain the content item immediately.

Also, when the minimum number of purchasers accepts the deal, the control 205 will typically be deactivated or hidden. In other words, once a deal is triggered because a sufficient number of buyers have accepted the deal, the content item becomes available for immediate purchase to everyone at the discount price. When the deal time period expires, the content item again becomes available only at the original base (non-discount) price, unless the content provider establishes a new deal (or re-initiates a prior deal).

Other techniques may be used in other embodiments to present information about the progress of a deal. For example, rather than or in addition to using the progress bar 203, other graphical depictions may be used, such as a pie chart, line graph, a thermometer metaphor, color indications (e.g., using colors from violet through red to indicate cold to hot, respectively), or the like. As another example, rather than or in addition to using the time remaining indicator 204, an animation of an analog clock may be used.

Note also that while deals are sometimes characterized in terms of offers and acceptance by content providers and buyers, the process of deal formation may be characterized in other ways. For example, a deal is sometimes described herein as an “offer” by a content provider to sell a content item at a discount price, conditioned upon a minimum number of acceptances within a particular time period. Also, users/buyers are typically described herein as “accepting” the deal (and thus accepting the offers for sale). In other embodiments, the deal may instead be characterized as an invitation by the content provider to make offers at a discount price, and buyers may correspondingly be described as making offers to purchase the content item at the discount price, the offers being accepted by the content provider upon receipt of the minimum number of offers. In short, the described techniques do not depend or rely upon the exact characterization of the process of contract formation between content providers, the operator of the media marketplace system, and/or the buyers.

FIG. 2B depicts the user interface screen 200 after the buyer has accepted the deal depicted in deal area 201. In particular, the buyer has selected the accept deal control 202. In response, a payment control 210 is displayed. The payment control 210 informs the buyer of the preferred payment mechanism and includes a control 211 for accessing a third-party payment processor 165 (FIG. 1) to initiate payment via that mechanism. Example third-party payment processors 165 include PayPal, Amazon Payments, banks, credit card processors, wire services, or the like.

FIG. 2C depicts a user interface screen 220 for providing access to a content item in response to a successful deal. In FIG. 2C, the required number of buyers have accepted the described with respect to FIG. 2A. In response, the media marketplace system displays the screen 220 to notify a buyer that the deal was successful. Screen 220 includes a control (e.g., button, link) 221 that can be used by the buyer to download, retrieve, or otherwise access the purchased content item. The screen 220 may be implemented or included within an email message transmitted to each buyer. Other embodiments transmit to each buyer an email message that includes a link to a Web page that renders as screen 220 on a client device of the buyer.

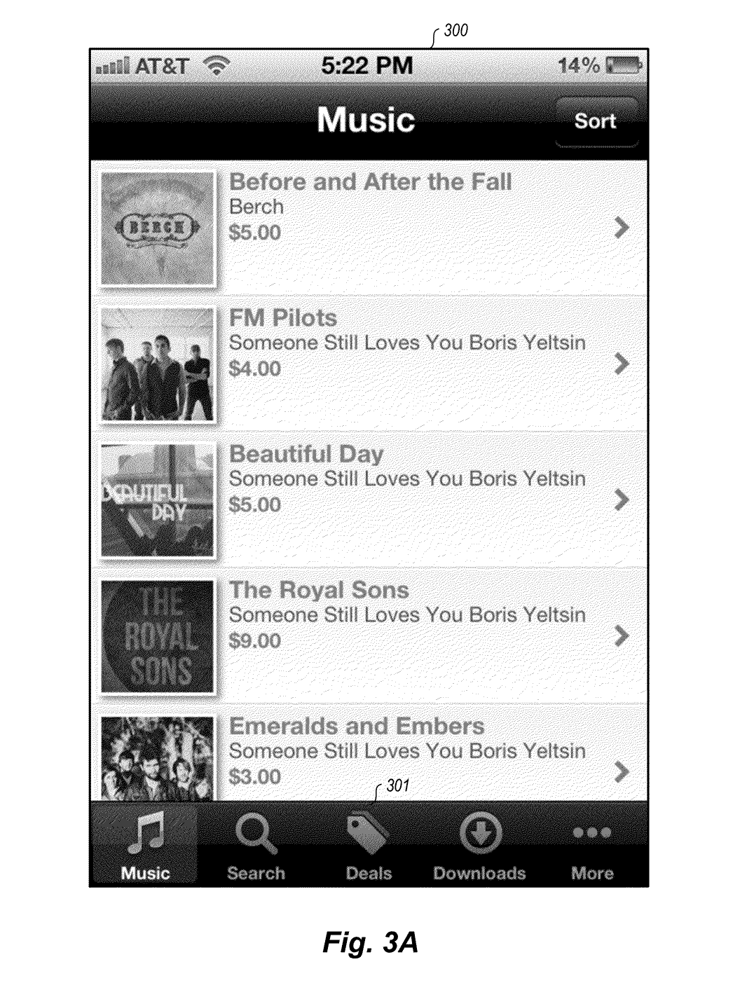

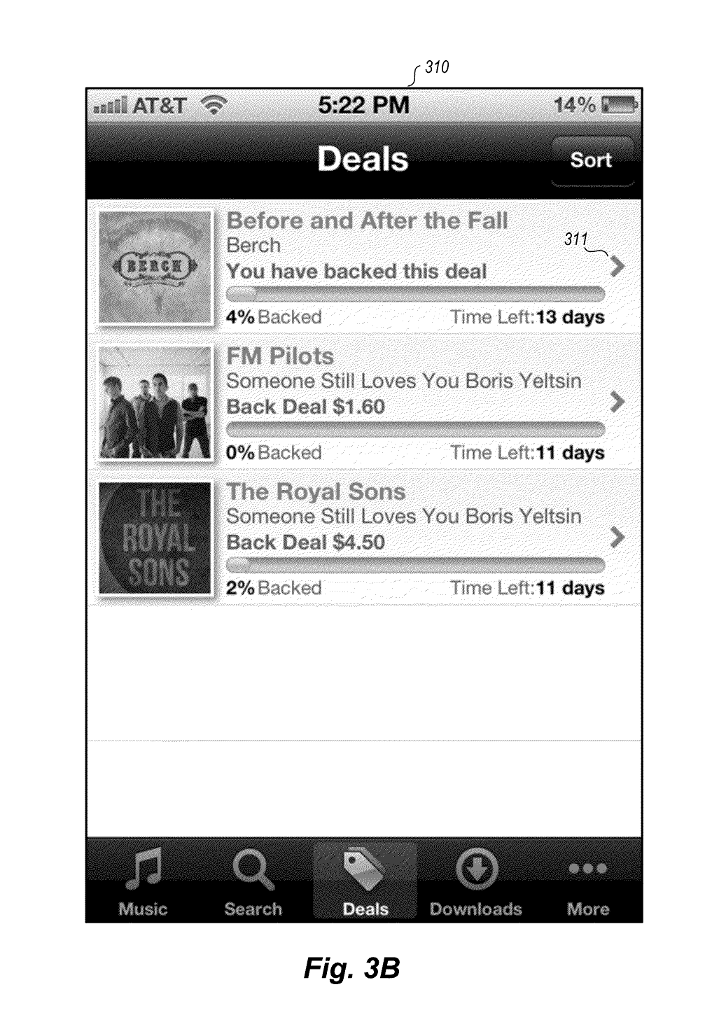

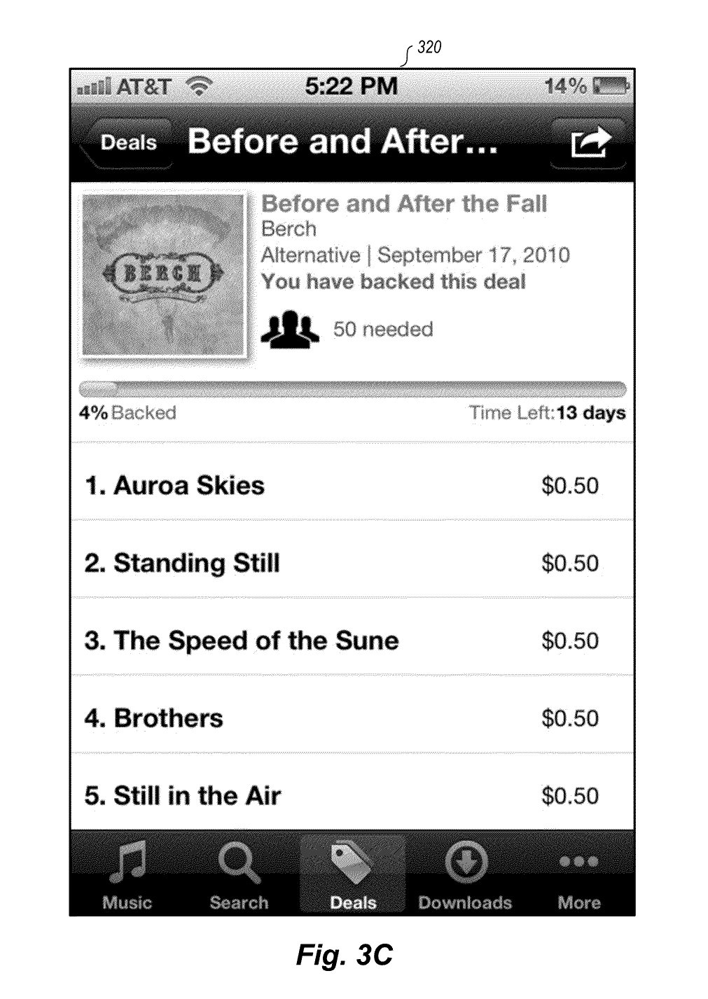

FIGS. 3A-3C illustrate mobile device user interface screens for engaging in a group purchase discount transaction for an electronic content item. FIG. 3A depicts a user interface screen 300 for browsing and otherwise obtaining information about content items that are available via an example media marketplace system. The screen 300 includes a deals control 301 that, when selected, initiates display of a user interface screen that provides information about ongoing deals, as described with respect to FIG. 3B, next.

FIG. 3B depicts a user interface screen 310 that provides information about ongoing deals. The screen 310 is similar to screen 200 described with respect to FIG. 2A. In addition, the screen 310 includes a deal detail control 311 that, when selected, initiates display of a deal details user interface screen, as described with respect to FIG. 3C, next.

FIG. 3C depicts a user interface screen 320 that provides detailed information about a single deal. The screen 320 displays how many more buyers are required under the deal (e.g., “50 needed”). In addition, the screen 320 displays more information about the content item associated with the deal. In this example, where the content item is an album, the screen 320 displays information about the individual songs of the album. Different information may be displayed here depending on the type of content item. For example, if the content item is an electronic book, a table of contents or book excerpts may be displayed. If the content item is a video, an embedded video player may be provided to facilitate previewing of the video content item.

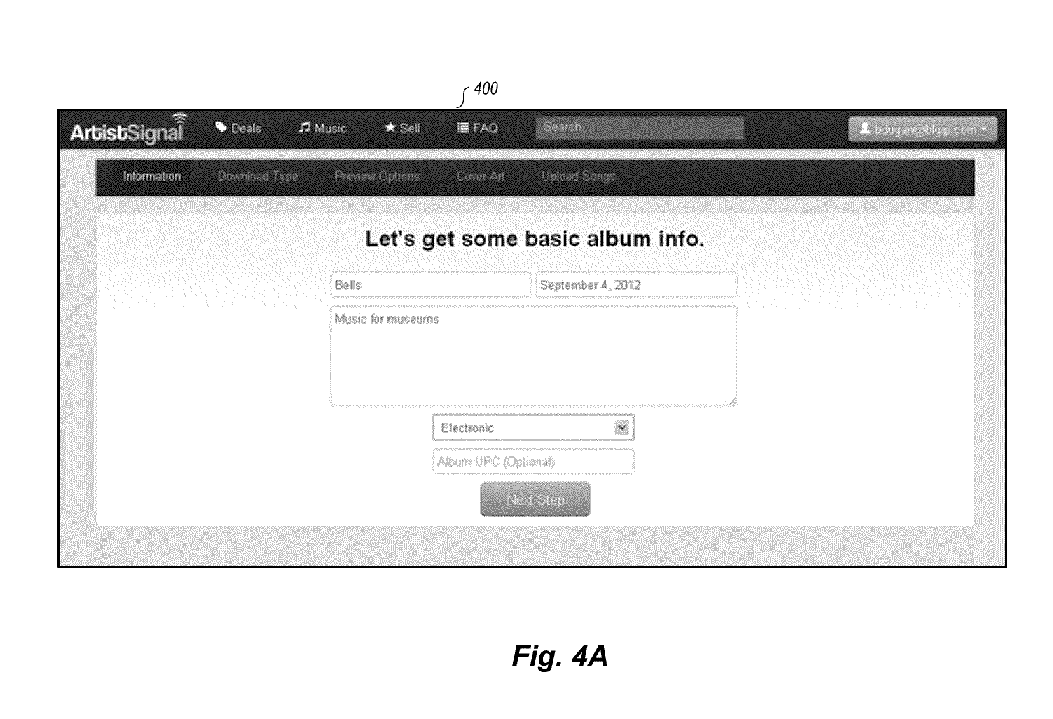

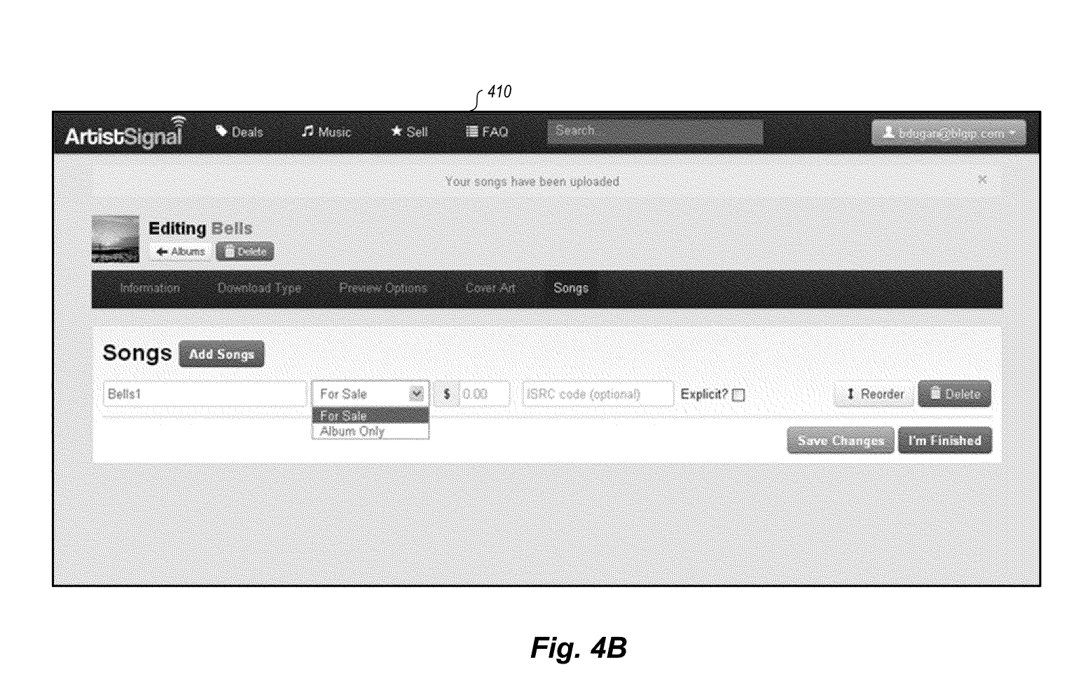

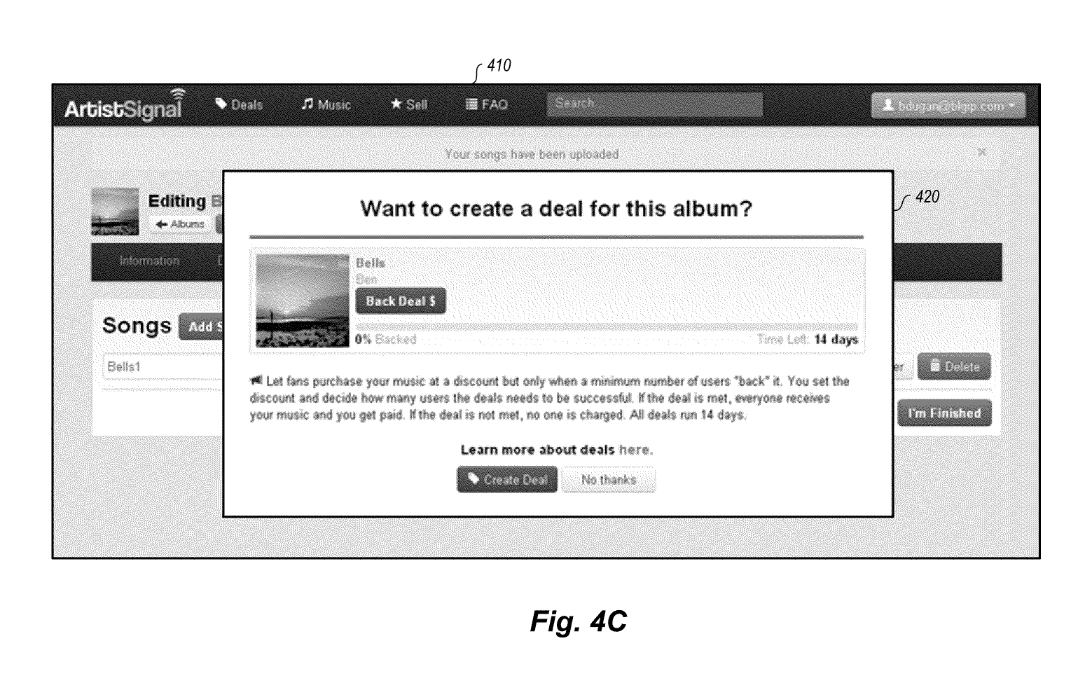

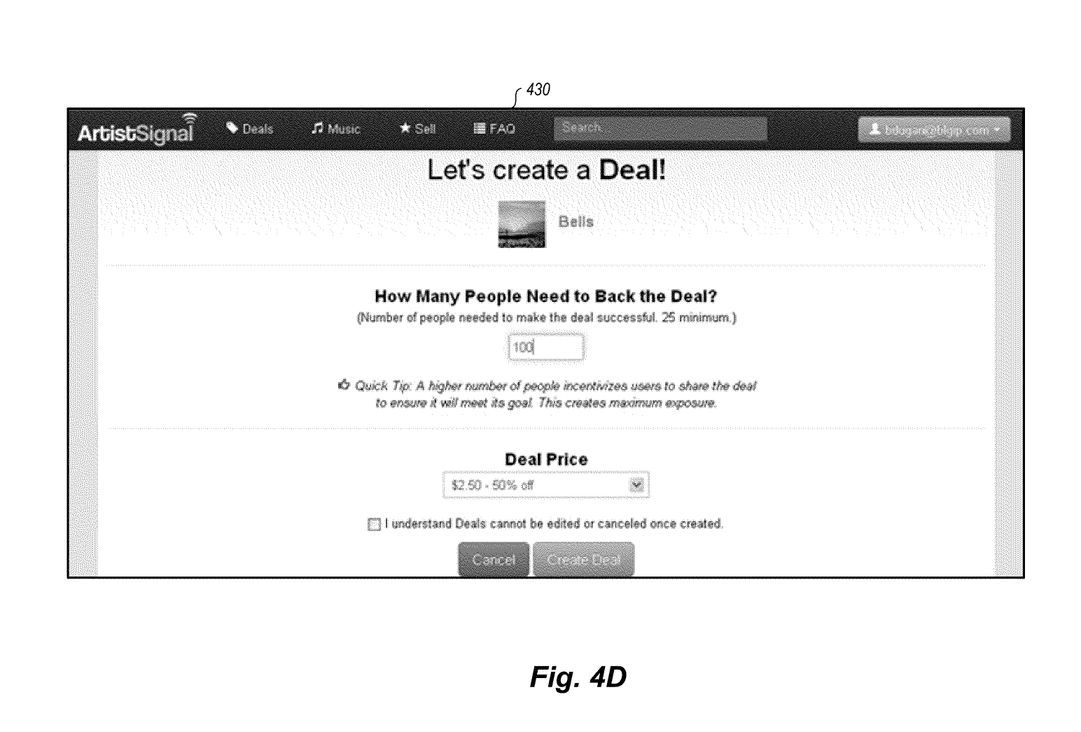

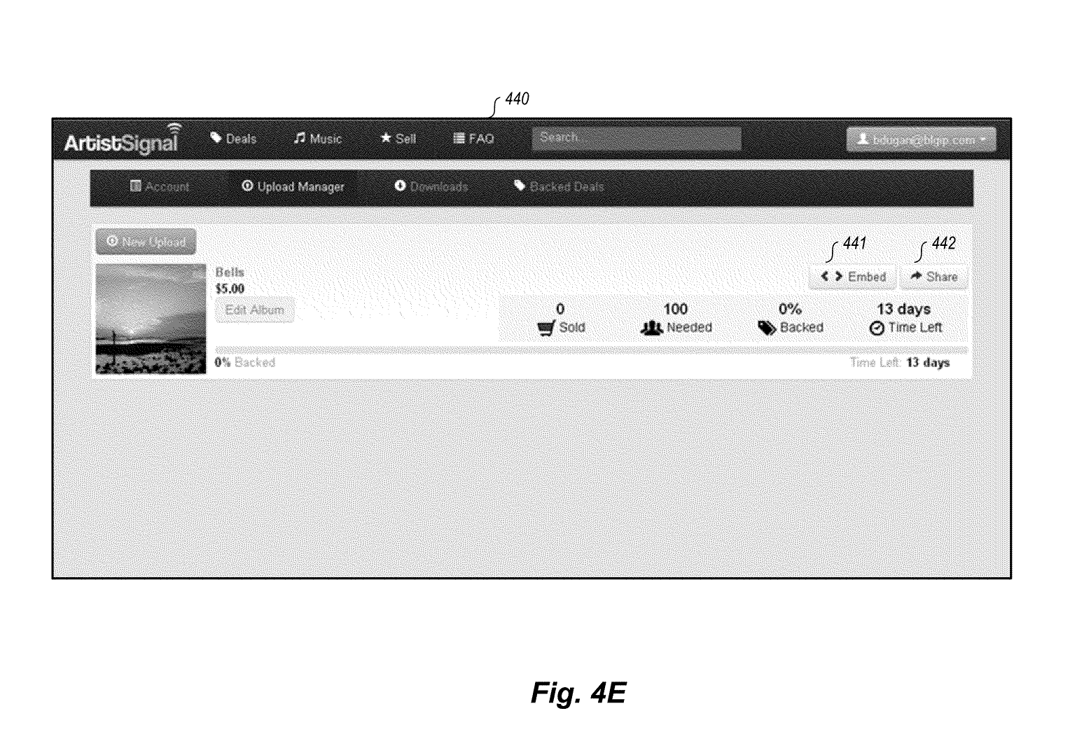

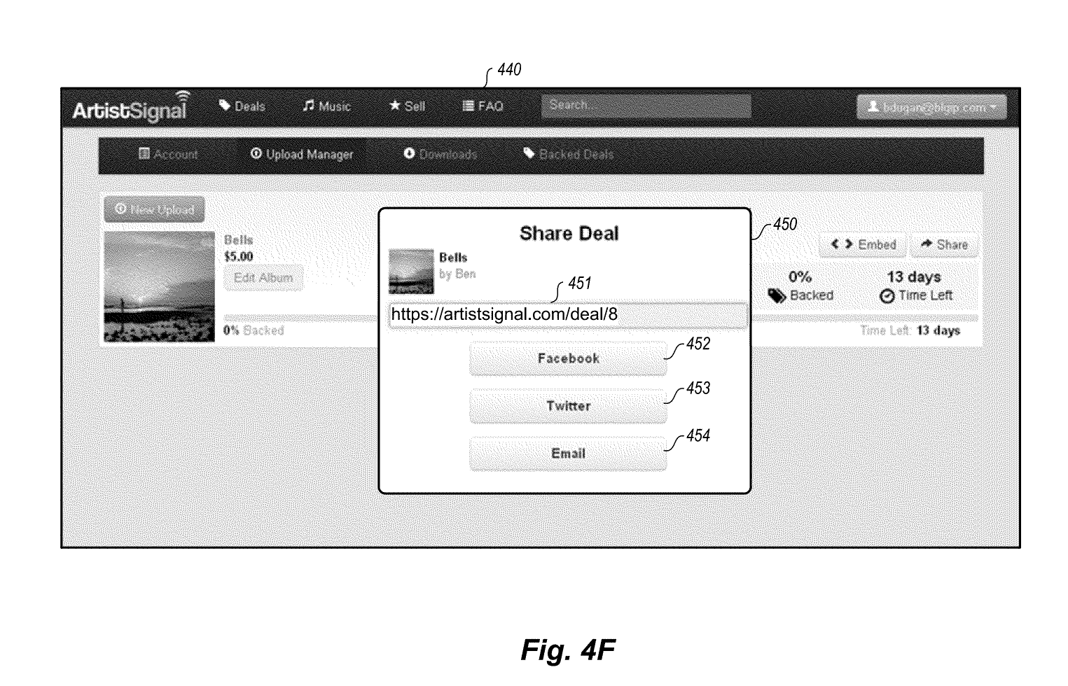

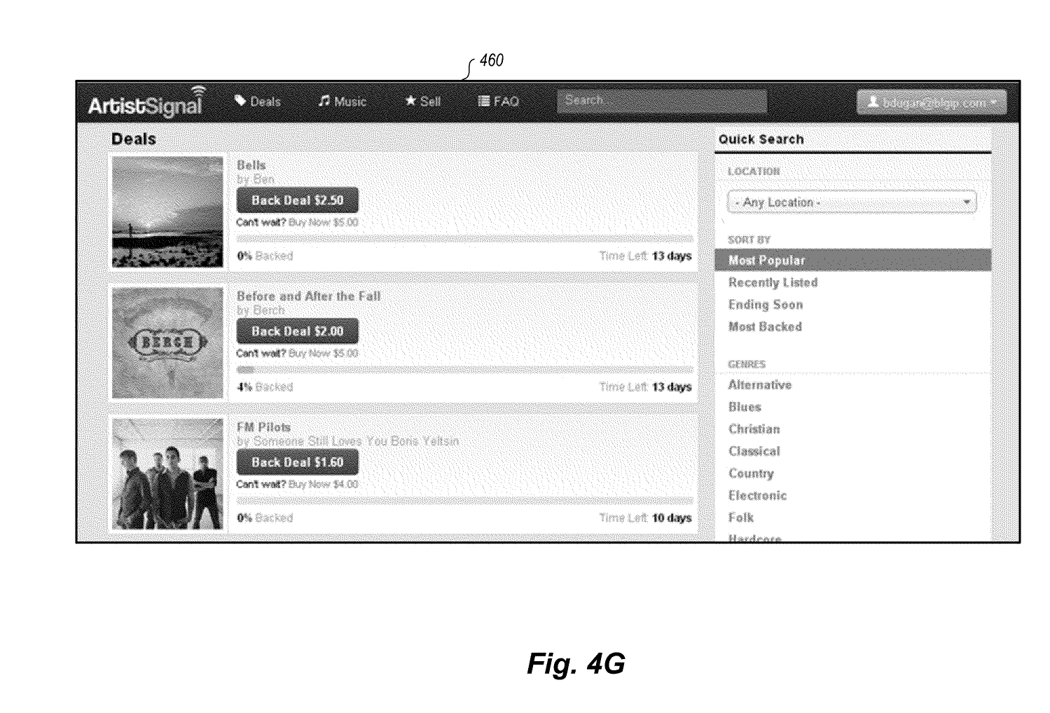

FIGS. 4A-4G illustrate user interface screens for establishing a group purchase discount associated with an electronic content item. FIGS. 4A-4G illustrate a running example in which a content provider uploads a content item (FIGS. 4A and 4B), establishes a deal associated with the content item (FIGS. 4C-4E), shares information about the deal (FIG. 4F), and finally views the deal in context with other deals or offers (FIG. 4G).

FIG. 4A depicts a user interface screen 400 for providing meta-information about a content item. The screen 400 includes controls that can be used by a content provider to provide information about a content item that is to be made available via the media marketplace system. In the illustrated example, the screen 400 includes controls for providing an album title, album date, description, genre, and universal product code (“UPC”).

FIG. 4B depicts a user interface screen 410 for uploading a content item. The screen 410 may be displayed in response to completion of screen 400, described above. Screen 410 includes controls for naming, pricing (e.g., specifying a base price), characterizing, ordering, and uploading songs that will form part of the album specified via screen 400. Songs may be uploaded in a variety of formats (e.g., WAV, MP3, OGG, etc.). Some embodiments convert and store uploaded songs in a uniform format (e.g., 320 kb/s MP3). Other embodiments allow the content provider to select from one of multiple supported formats, so that the content provider can select from different quality or compression profiles.

FIG. 4C depicts a user interface screen 420 for initiating creation of a deal. The screen 420 may be displayed in response to completion of screen 410, described above. Screen 420 provides the content provider with introductory information about deals and an option to create a deal with respect to the recently uploaded content item.

FIG. 4D depicts a user interface screen 430 for specifying terms of a deal. The screen 430 may be displayed in response to a received indication that the content provider wishes to create a deal (e.g., via screen 420). Screen 430 includes controls for specifying the minimum number of buyers (e.g., 100) and the deal (discount) price. In the illustrated embodiment, all deals last 14 days. However, in other embodiments, the content provider can specify the deal duration via a control on screen 430 or some similar mechanism.

FIG. 4E depicts a user interface screen 440 for managing a deal. The screen 440 may be displayed in response to successful completion of screen 430, described above. The screen 440 displays information about a deal, including content item details, a deal progress bar, and a time remaining indicator, as described with respect to FIG. 2A. In addition, the screen 440 displays the number of buyers who have accepted the deal and the number of buyers required under the deal.

The screen 440 also includes an embed control 441 and a sharing control 442. The embed control 441, when selected by the content provider, initiates display of embedding code. Embedding code may be or include an HTML snippet or segment that can be embedded or otherwise included in a Web page that, when rendered by a client browser, causes information about the deal to be displayed, along with a link or other control for accessing (e.g., viewing or accepting) the deal. Other embodiments may provide embedding code in other formats or languages, including XML, JavaScript, or the like. The sharing control 442, when selected by the content provider, initiates display of a sharing user interface screen as described with respect to FIG. 4F, next.

FIG. 4F depicts a user interface screen 450 for sharing information about a deal. The screen 450 may be displayed in response to selection of the sharing control 442 of FIG. 4E, above. The screen 450 includes a URL 451 to the deal. The URL 451 may be copied by the content provider and included on a Web page (e.g., blog, article), email, or the like.

The screen 450 also includes buttons 452-454 for respectively sharing information about the deal via a social networking service, a micro-blogging service, and email. Selection of any one of the illustrated buttons initiates preparation and/or transmission of a message via a corresponding application. For example, when the content provider selects the button 452 (“Facebook”), a message (e.g., a status update) about the deal is automatically posted to the content provider's account on that social networking service. Typically, the posted or transmitted message will include a link to the deal and/or controls for directly accepting the deal.

The credentials used to access the content provider's social networking (or other messaging) account may have been previously obtained and stored by the media marketplace system, so that the content provider need not re-enter them to perform the illustrated messaging operation. In this manner, information about the deal may be shared via a single selection (e.g., click) or other operation.

Note that the screen 450 (or a similar screen) may be presented in other contexts as well. In particular, users other than the content provider can share information about a deal by using a screen similar to the screen 450. In general, the URL 451 or other links that are transmitted may be personalized, tagged, or otherwise include identifying information so their use can be tracked for referral purposes. For example, suppose a user operates screen 450 to transmit the URL 451 to his social network comprising 100 friends. The media marketplace system will track accesses via the URL 451, and associate those accesses with the user. For example, the media marketplace system may record that twenty users accessed and five users accepted the deal via the URL 451.

Some embodiments provide rewards for referrals. In one embodiment, users who accepts a deal will receive the deal for free if they generate at least a minimum number of referrals. For example, if the user accepts a deal and then shares information about the deal (e.g., via a URL 451), resulting in at least three additional acceptances of the deal, the user will receive the deal for free. Other embodiments may reward referrals in different ways. For example, one embodiment may provide a user with credits towards other purchases via the media marketplace system. The number of credits may be based on how many referrals are obtained.

FIG. 4G depicts a user interface screen 460 for displaying a deal to a buyer. The screen 460 is similar to the screen 200 (FIG. 2A) and includes information about the deal established as described with respect to FIGS. 4A-4F, above.

Note that deals may be structured differently in other embodiments. In some embodiments, a deal may specify the discount price as a continuous or multiple stepwise function of the number of buyers. For example, the price for a content item may be inversely related to the number of buyers who accept the deal. The greater the number of buyers to accept the deal, the lower the final discount price. In another embodiment, greater discounts may be afforded to those buyers who accept the deal early. For example, the first 1000 buyers to accept the deal may receive the item for $3.00 (instead of the base price of $5.00); the next 1000 buyers receive the item for $3.50; and any additional buyers receive the item for $4.00.

### Example Process

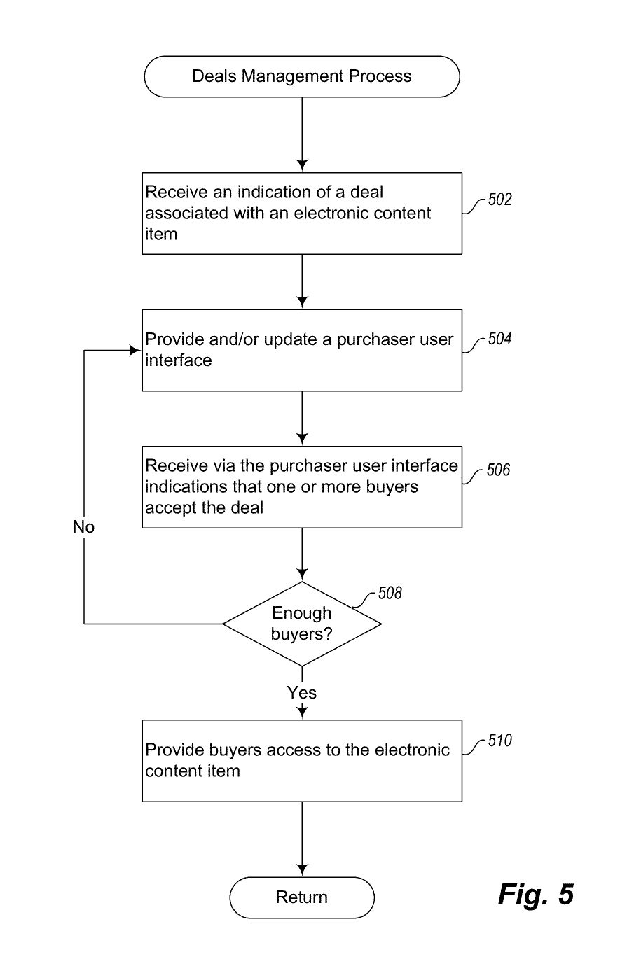

FIG. 5 is a flow diagram of an example deal manager process according to an example embodiment. The process of FIG. 5 may be performed or implemented by one or more of the modules of the media marketplace system 100, such as the deal manager 112, described with respect to FIG. 1.

The illustrated process begins at block 502, where it receives an indication of a deal associated with an electronic content item. Receiving the indication of the deal may include receiving indications of a base price at which the electronic content item can be purchased immediately and a discount price at which the electronic content item can be purchased if more than a specified number of buyers accept the deal within a time period. In some cases, the time period may be specified by a content provider or other user. In other embodiments, the time period may be fixed.

At block 504, the process provides and/or updates a purchaser user interface. The purchaser user interface may include one or more controls for providing information about the deal, such as the base price, the discount price, how much time is remaining, how many buyers have accepted the deal, how many additional buyers are required under the deal, how many total buyers are required under the deal, and the like. Providing the user interface may include generating, formatting, and/or transmitting a representation of (e.g., computer instructions, HTML code) of the user interface for rendering by client systems or devices operated by prospective buyers. Updating the user interface may include causing a user interface (as presented on a client system) to update a progress indicator, such as when an additional buyer accepts the deal.

At block 506, the process receives via the purchaser user interface indications that one or more buyers accept the deal. Receiving indications that buyers have accepted the deal may include receiving a network request, message, or indication (e.g., an HTTP request) from a remote client system that is presenting the user interface to a buyer.

At block 508, the process determines whether enough buyers have accepted the deal. If so, the process continues at block 510, otherwise at block 504. Block 508 may include additional logic, such as determining whether the time period corresponding to the deal has expired. If so, the process may notify the prospective buyers that the deal was unsuccessful and provide them with the option to purchase the content item at the base (full) price.

At block, 510, the process provides buyers access to the electronic content. Providing access to the electronic content item may include transmitting the content item and/or transmitting a link or other reference to the item, which may then be used by the buyer to access or download the content item.

After block 510, the process ends. In other embodiments, the process returns to block 502 to process additional deals.

Other embodiments may include companion processes that execute on client devices and that are configured to interact with the process of FIG. 5. For example, some embodiments may provide an application (“app”) for a mobile device that is configured to allow content providers to provide content and establish deals and/or buyers to accept deals and otherwise purchase content items from the media marketplace system.

### Example Computing System Implementation

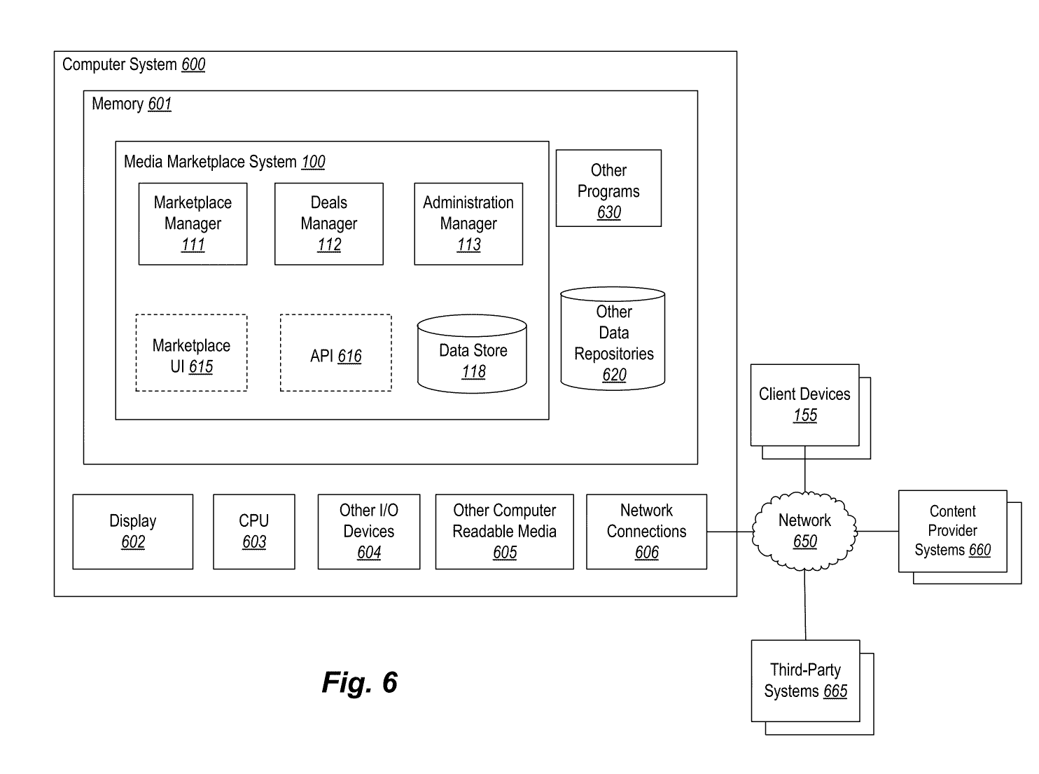

FIG. 6 is a block diagram of an example computing system for implementing a media marketplace system according to an example embodiment. In particular, FIG. 6 shows a computing system 600 that may be utilized to implement a media marketplace system 100 that facilitates media transactions as described herein.

Note that one or more general purpose or special purpose computing systems/devices/processors, suitably instructed, may be used to implement the media marketplace system 100. In addition, the computing system 600 may comprise one or more distinct computing systems/devices and may span distributed locations. Furthermore, each block shown may represent one or more such modules as appropriate to a specific embodiment or may be combined with other blocks. Also, the media marketplace system 100 may be implemented in software, hardware, firmware, or in some combination to achieve the capabilities described herein.

In the embodiment shown, computing system 600 comprises a computer memory (“memory”) 601, a display 602, one or more Central Processing Units (“CPU”) 604, Input/Output devices 604 (e.g., keyboard, mouse, speakers, and the like), other computer-readable media 605 (e.g., optical disk, magnetic disk, flash drive), and network connections 606. The media marketplace system 100 is shown residing in memory 601. In other embodiments, some portion of the contents, some or all of the components of the media marketplace system 100 may be stored on and/or transmitted over the other computer-readable media 605. The components of the media marketplace system 100 preferably execute on one or more CPUs 603 and facilitate media transactions, as described herein. Other code or programs 630 (e.g., an administrative interface, a Web server, and the like) and potentially other data repositories, such as data repository 620, also reside in the memory 601, and preferably execute on one or more CPUs 603. Of note, one or more of the components in FIG. 6 may not be present in any specific implementation. For example, some embodiments may not provide or include the other computer-readable media 605 or the display 602.

In the illustrated embodiment, the media marketplace system 100 includes a marketplace manager 111, a deals manager 112, an administration manager 113, and a data store 118, as described with respect to FIG. 1. The illustrated media marketplace system 100 also includes a media marketplace user interface (“UI”) 615 and a media marketplace application program interface (“API”) 616. The UI 615 and API 616 are drawn in dashed lines to emphasize that in other embodiments, functions performed by one or more of these components may be performed externally to the media marketplace system 100. In other embodiments, the media marketplace system 100 includes additional modules and/or modules that are decomposed or arranged in a different manner.

The UI 615 provides a view and a controller that facilitate user interaction with the media marketplace system 100 and its various components. For example, the UI 615 may provide interactive access to the media marketplace system 100, so that users (e.g., content providers, buyers) can upload content items, establish deals, browse available content items/deals, accept deals, download content items, or the like. In some embodiments, access to the functionality of the UI 615 may be provided via a Web server, possibly executing as one of the other programs 630. Users may then operate Web browsers executing on client devices 155 to access the functions of the media marketplace system 100.

The API 616 provides programmatic access to one or more functions of the media marketplace system 100. For example, the API 616 may provide a programmatic interface to one or more functions of the media marketplace system 100 that may be invoked by one of the other programs 630 or some other module. In this manner, the API 616 facilitates the development of third-party software, such as user interfaces, plug-ins, news feeds, adapters (e.g., for integrating functions of the media marketplace system 100 into Web applications), and the like. In addition, the API 616 may be in at least some embodiments invoked or otherwise accessed via remote entities, such as one of the client devices 155, content provider systems 660, and/or third-party systems 665. For example, a content provider system 660 may register via the API 616 to receive an information feed regarding the progress of a deal.

The media marketplace system 100 may interact via the network 650 with client devices 155, content provider systems 660, and third-party systems 665. The network 650 may be any combination of media (e.g., twisted pair, coaxial, fiber optic, radio frequency), hardware (e.g., routers, switches, repeaters, transceivers), and protocols (e.g., TCP/IP, UDP, Ethernet, Wi-Fi, WiMAX) that facilitate communication between remotely situated humans and/or devices. The client devices 155 include personal computers, laptop computers, notebook computers, mobile phones, smart phones, tablet computers, personal digital assistants, kiosk systems, and the like.

The data store 118 is used by the modules of the media marketplace system 100 to store and/or communicate information. The components of the media marketplace system 100 use the data store 118 to record various types of information, including content items, content item meta-information, deal information, user information, and the like. Although the components of the media marketplace system 100 are described as communicating primarily through the data store 118, other communication mechanisms are contemplated, including message passing, function calls, pipes, sockets, shared memory, and the like.

In an example embodiment, components/modules of the media marketplace system 100 are implemented using standard programming techniques. For example, the media marketplace system 100 may be implemented as a “native” executable running on the CPU 603, along with one or more static or dynamic libraries. In other embodiments, the media marketplace system 100 may be implemented as instructions processed by a virtual machine that executes as one of the other programs 630. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described above may also use either well-known or proprietary synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Also, other functions could be implemented and/or performed by each component/module, and in different orders, and by different components/modules, yet still achieve the described functions.

Different configurations and locations of programs and data are contemplated for use with techniques of described herein. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, and the like). Also, other functionality could be provided by each component/module, or existing functionality could be distributed amongst the components/modules in different ways, yet still achieve the functions described herein.

In addition, programming interfaces to the data stored as part of the media marketplace system 100, such as in the data store 118, can be available by standard mechanisms such as through C, C++, C#, and Java APIs; libraries for accessing files, databases, or other data repositories; through markup languages such as XML; or through Web servers, FTP servers, or other types of servers providing access to stored data. The data store 118 may be implemented as one or more database systems, file systems, or any other technique for storing data, or any combination of the above, including implementations using distributed computing techniques.

Furthermore, in some embodiments, some or all of the components of the media marketplace system 100 may be implemented or provided in other manners, such as at least partially in firmware and/or hardware, including, but not limited to one or more application-specific integrated circuits (“ASICs”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Some or all of the system components and/or data structures may be stored as non-transitory content on one or more tangible computer-readable mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

While the preferred embodiment of the invention has been illustrated and described, as noted above, many changes can be made without departing from the spirit and scope of the invention. For example, different types of content items, including those in physical form (e.g., books) or other formats (e.g., video, still images, electronic books), may be sold using the described techniques. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for facilitating a transaction for an electronic content item, the method comprising:
receiving an indication of the electronic content item;
receiving an indication of a deal associated with the electronic content item, the deal including a base price at which the electronic content item can be purchased immediately and a discount price at which the electronic content item can be purchased if more than a specified number of buyers accept the deal within a specified time period; and
providing a purchaser user interface that includes a control for purchasing the electronic content item immediately, a control for accepting the deal, an indication of the base price, an indication of the discount price, an indication of how much time is remaining within the specified time period, and an indication of a quantity of buyers that have accepted the deal;
receiving via the purchaser user interface indications that one or more buyers accept the deal; and
when the quantity of buyers that have accepted the deal at least equals the specified number of buyers, providing the one or more buyers access to the electronic content item in exchange for the discount price.

2. The method of claim 1, further comprising:
when the specified time period expires and the quantity of buyers that have accepted the deal is less than the specified number of buyers, notifying the one or more buyers that an insufficient number of buyers have accepted the deal and offering the electronic content item for sale at the base price.

3. The method of claim 1, further comprising:
providing the one or more buyers access to the electronic content item only when at least the specified number of buyers have accepted the deal within the specified time period.

4. The method of claim 1, wherein providing the purchaser user interface includes generating a graphical depiction how many buyers have accepted the deal.

5. The method of claim 4, wherein generating the graphical depiction includes generating a bar graph having a line, the length of which is directly proportional to the quantity of buyers that have accepted the deal.

6. The method of claim 1, wherein providing the purchaser user interface includes transmitting a module to a remote client device, wherein the module is configured, when processed by the client device, to cause the client device to display the purchaser user interface.

7. The method of claim 1, further comprising:
in response to the received indications that one or more buyers accept the deal, causing the purchaser user interface to display an animated update of the indication of the quantity of buyers that have accepted the deal.

8. The method of claim 1, wherein receiving the indication of the deal includes receiving a user-specified indication of the specified time period.

9. The method of claim 1, further comprising:
providing a deal sharing user interface that is configured to initiate transmission of a link on behalf of a buyer that accepted the deal to the purchaser user interface via one or more of electronic mail, a social network service, and a micro-blogging service.

10. The method of claim 9, further comprising:
recording how many buyers access and accept the deal via the transmitted link; and
when the number of buyers that accept the deal at least equals a specified number, providing free of charge access to the electronic content item to the buyer that accepted the deal and transmitted the link.

11. The method of claim 1, wherein receiving the indication of the electronic content item includes receiving an indication of at least one of a song, an album, a video, an electronic book, an audio book, and an image.

12. The method of claim 1, wherein receiving the indication of the electronic content item includes receiving and storing the electronic content item.

13. The method of claim 1, wherein providing the one or more buyers access to the electronic content item includes transmitting the electronic content item to each of the one or more buyers.

14. The method of claim 1, wherein providing the one or more buyers access to the electronic content item includes transmitting a link to the electronic content item to each of the one or more buyers.

15. A computer-readable storage medium including contents that, when processed by a computing system, cause the computing system to facilitate a transaction for an electronic content item by performing a method comprising:
receiving an indication of the electronic content item;
receiving an indication of a deal associated with the electronic content item, the deal including a base price at which the electronic content item can be purchased immediately and a discount price at which the electronic content item can be purchased if more than a specified number of buyers accept the deal within a specified time period; and
providing a purchaser user interface that includes a control for purchasing the electronic content item immediately, a control for accepting the deal, an indication of the base price, an indication of the discount price, an indication of how much time is remaining within the specified time period, and an indication of a quantity of buyers that have accepted the deal;
receiving via the purchaser user interface indications that one or more buyers accept the deal; and
when the quantity of buyers that have accepted the deal at least equals the specified number of buyers, providing the one or more buyers access to the electronic content item in exchange for the discount price.

16. The computer-readable storage medium of claim 14, wherein receiving the indications that one or more buyers accept the deal includes:
receiving an indication that one or more buyers have selected the control for accepting the deal;
receiving an indication that one or more buyers have selected the control for purchasing the electronic content item immediately; and
counting both the buyers that have selected the control for accepting the deal and the buyers that have selected the control for purchasing the electronic content item immediately as buyers that have accepted the deal.

17. A computing system for facilitating a transaction for an electronic content item, the system comprising:
a processor;
a memory; and
a module that is stored on the memory and that is configured, when executed by the processor, to:
receive an indication of the electronic content item;
receive an indication of a deal associated with the electronic content item, the deal including a base price at which the electronic content item can be purchased immediately and a discount price at which the electronic content item can be purchased if more than a specified number of buyers accept the deal within a specified time period; and
provide a purchaser user interface that includes a control for purchasing the electronic content item immediately, a control for accepting the deal, an indication of the base price, an indication of the discount price, an indication of how much time is remaining within the specified time period, and an indication of a quantity of buyers that have accepted the deal;
receive via the purchaser user interface indications that one or more buyers accept the deal; and
when the quantity of buyers that have accepted the deal at least equals the specified number of buyers, provide the one or more buyers access to the electronic content item in exchange for the discount price and remove the control for purchasing the electronic content item immediately from the purchaser user interface, thereby making the electronic content item available to all buyers at the discount price for the remainder of the specified time period.

18. The computing system of claim 18, wherein the module is a media marketplace module that is further configured to:
transmit the purchaser user interface to multiple remote client devices that are operated by potential buyers.

19. The computing system of claim 18, wherein the module is further configured to:
initiate payment by each of the buyers that have accepted the deal via a third-party payment processor; and
initiate payment to a provider of the electronic content item, the payment based on a total of the payments by each of the buyers that have accepted the deal.

20. The computing system of claim 18, wherein the module is further configured to:
receive an indication that a buyer desires to purchase the electronic content item immediately;
provide the buyer access to the electronic content item in exchange for a payment; and
count the buyer that purchased the electronic content item immediately towards the specified number of buyers.
